(19) United States
(12) Patent Application Publication
(10) Pub. No.: US 2018/0149515 A1
(43) Pub. Date: May 31, 2018

(54) PROTECTIVE DEVICE FOR A WEIGHING PLATFORM

(71) Applicant: Robert Bosch Limitada, Campinas - SP (BR)

(72) Inventors: Alvaro Augusto Vasconcelos, Campinas - SP (BR); Luis Fernando L. Ribeiro, JR., Campinas - SP (BR)

(21) Appl. No.: 15/824,332

(22) Filed: Nov. 28, 2017

(30) Foreign Application Priority Data
Nov. 29, 2016 (BR) BR202016028036-8

(51) Int. Cl. G01G 21/30

(52) U.S. Cl. CPC G01G 21/30

(57) ABSTRACT

A protective device (10) for a weighing platform (1), particularly for weighing animals, the weighing platform (1) comprising a weighing plate that defines two longitudinal ends, wherein at each of the plate (2) ends a protective device (10) is arranged, which, when projected in side view, defines an L-shaped profile (11), the profile (11) comprising a lower end (12) that defines a base for supporting the protective device (10) and an upper end (13) that is mounted near end of the plate (12) of the weighing platform (1), being capable of barring dirt brought by the animals, preventing the accumulation of residues/debris under the platform (1), which might entail problems in the precision of the weighing or even lead to locking of the platform (10).

### BACKGROUND OF THE INVENTION

The present invention relates to a protective device for a weighing platform disclosed in patent application BR 10 2015 026489-5.

Weighing platforms are devices that optimize the weighing of animals. Weighing platforms generally accommodate weighing bars that are positioned under its structures and are applied in various areas, including in the cattle-breading branch, where often there is the need to weigh animals with precision and in large numbers. Therefore, it is necessary to employ robust, precise and durable equipment.

Due to the different places where weighing platforms are applied, for example, in the open field, exposed to rainwater and mud, there is a need to have an easy-to-maintain-and-clean assembly

One does not observe, in the prior art, a weighing platform that comprises at least one protection device arranged at each of its longitudinal ends, capable of barring the dirt deposited on the platform, preventing the accumulation of residues/debris under the platform, which might entail problems in the precision weighing, or even lead to equipment locking.

### SUMMARY OF THE INVENTION

The objective lies in providing a protective device for a weighing platform, which is arranged at the longitudinal ends of the platform and is capable of barring dirt during the weighing of animals, preventing accumulation of residues/debris under the platform.

The objectives of the present invention are achieved by means of a protective device for a weighing platform, which comprises a weighing plate, which defines two longitudinal ends, wherein at each of the plate ends a protective device is provides, which, when projected in side view, defines an L-shaped profile, the profile comprising a lower end that defines a horizontal base for the protective device and an upper base that is mounted near the end of the plate of the weighing platform.

### BRIEF DESCRIPTION OF THE DRAWINGS

The present invention will now be described in greater detail with reference to the drawings. The figures show:

FIG. 1—a perspective view of the weighing platform comprising the protective device of the invention; and

FIG. 2—a side view of the weighing platform comprising the protective device of the invention.

### DETAILED DESCRIPTION

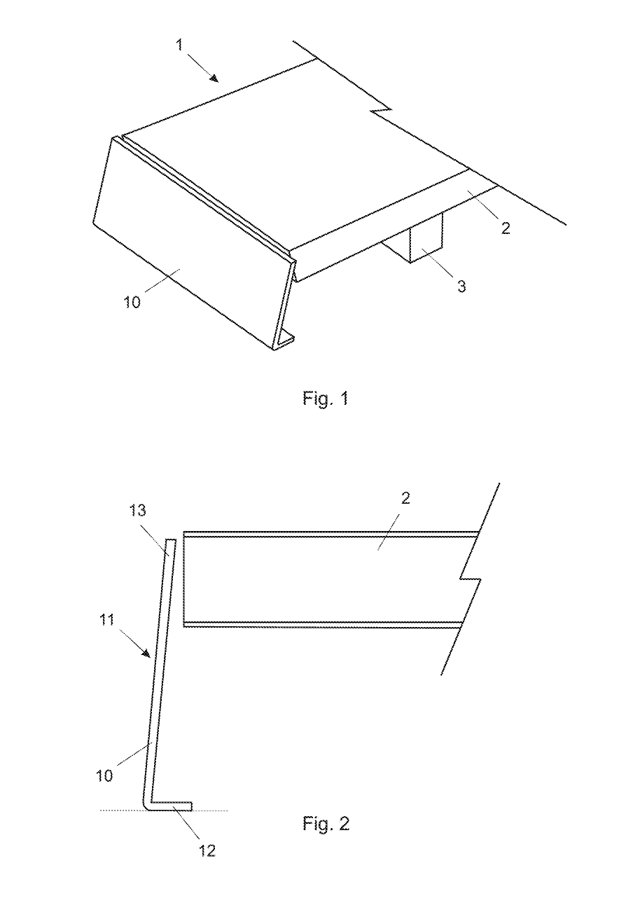

With reference to the drawings, one observes, in FIG. 1, a weighing platform 1 comprising a weighing plate 2 that defines two longitudinal ends, each of the ends being supported on a bar 3 and comprising a protective device 10.

In FIG. 2 one observes the supportive device 10 of the present model, which, when projected in side view, defines an L-shaped profile 11 and is arranged at one of the longitudinal ends of the platform 1.

The profile 11 comprises a lower end 12 defining a horizontal base for supporting the protective device 10 and an upper end 13 that is mounted near the end of the plate 2, defining a minimum space sufficient to enable movement of the plate 2 with respect to the protective device 10.

The protective device 10 is manufactured from a metallic or polymeric material, depending on the need of the environment and design. The thicknesses, widths and heights of the protective device 10 vary according to the design of the weighing platform 1.

The protective device 10 has the objective of barring dirt brought by the animals during the weighing, preventing the accumulation of residues/debris under the platform 1. It is important that such accumulation of dirt be prevented, since it might entail problems in the precision of the weighing or even result in locking the platform 1.

1. A protective device for a weighing platform, the weighing platform (1) comprising a weighing plate (2) that defines two longitudinal ends, characterized in that the protective device (10) is arranged in each of the longitudinal ends, protective device (10) which, when projected in side view, defines an L-shaped profile (11), the profile (11) comprising a lower end (12) that defines a horizontal base for supporting the protective device (10) and an upper end (13) that is mounted near the longitudinal end of the weighing plate (2).
